(19) United States
(12) Patent Application Publication
(10) Pub. No.: US 2009/0138925 A1
(43) Pub. Date: May 28, 2009

(54) Content distribution system

(76) Inventors: Kevin P. Headings, Pacific Palisades, CA (US); Joseph T. Hayes, Torrance, CA (US); Samuel J. Beckman, Thousand Oaks, CA (US); David Wong, Los Angeles, CA (US); Kenneth Lau, Los Angeles, CA (US); Richard T. O'Halloran, Pacific Palisades, CA (US)

Correspondence Address: MARTIN & FERRARO, LLP, 1557 LAKE O'PINES STREET, NE, HARTVILLE, OH, 44632, US

(21) Appl. No.: 12/322,123

(22) Filed: Jan. 29, 2009

Related U.S. Application Data
(63) Continuation of application No. 09/921,096, filed on Jul. 31, 2001.
(60) Provisional application No. 60/280,626, filed on Mar. 30, 2001.

(51) Int. Cl. H04N 7/173

(52) U.S. Cl. 725/109

(57) ABSTRACT

The present invention is directed to systems and methods for distributing and managing media assets arranged as a collection of media content. In one preferred embodiment, the collection of media content is distributed to a storage location where it is accessible for viewing over a communications network by consumers for a selected interval of time. In another preferred embodiment, media content is downloaded to a client content database and made accessible for a selected interval of time by client software at the consumer's location.

### RELATED APPLICATION

This application is a continuation of U.S. application Ser. No. 09/921,096, filed Jul. 31, 2001; which claims the benefit of U.S. Provisional Application No. 60/280,626, filed Mar. 30, 2001; all of which are incorporated by reference herein.

### BACKGROUND OF THE INVENTION

The digitization of media content (e.g., movies, music videos, educational content, television shows, games, live events, advertising, literary works, audio programs, and other media assets) is becoming more common with the advent of technology that allows content suppliers to derive revenues from these assets in a digital marketplace. Content suppliers may include entities that own the content, have rights to the content, or are otherwise suppliers of the media assets. For purposes herein, media assets form a subset of media content. There is a cost for entry into the digital space that requires infrastructure and processes to effectively manage and distribute various forms of media assets, particularly over high bandwidth channels of communication (e.g., digital cable, Internet protocol, and satellite). Content suppliers are not traditionally equipped to handle these requirements and would benefit from a system that minimizes the barrier to entry into the digital marketplace.

Users of content also have barriers in the digital marketplace. For purposes hereof, a “content user” is any person or entity that sells or otherwise exploits media assets. A content user may be, for example, the content supplier, a digital services platform operator, an online site builder, an educational institution, or a retailer. One issue facing content users is the distribution of media assets to consumers over one or more delivery platforms (e.g., digital subscriber line (DSL), cable and satellite). For purposes hereof, “consumers” are people who view, listen, or interact with the content (e.g., people watching television). Content suppliers often want to control the timing and manner of distribution of their content to a consumer. For example, a movie content supplier may release a movie for distribution only after a selected amount of time has elapsed since the movie's theater run, or a particular season in line with the content of the movie (e.g., distributing scary movies during the Halloween season, or Christmas movies during the Christmas season). The movie content supplier may further specify, for example, an amount charged per viewing, the mode of delivery to an end viewer, and a limited geographic region for release. In addition to placing these and other restrictions or limitations on the distribution of media assets, content suppliers usually require payment of royalties.

Distributor networks are not suitably equipped to handle the ever-increasing myriad of considerations such as rules and restrictions associated with delivering media assets to a consumer. Therefore, there exists a need for a system and method adapted to manage media assets in compliance with a variety of distribution rules and distribute the media assets to a consumer.

### SUMMARY OF THE INVENTION

The present invention is directed to systems and methods for distributing and managing media assets. Media assets are preferably arranged as a collection of content for exhibition during a designated period (viewing window), and are made available for distribution to consumers during such period.

In a preferred embodiment, the present invention facilitates distribution of content to one or more storage locations, and distribution of content from the storage locations to consumers. Before media content is distributed, it is preferably prepared by a content management system. The content management system preferably provides a naming convention for media assets by associating media assets with metadata (i.e., descriptive information regarding a particular asset), prepares the media assets for delivery to particular groups of consumers (e.g., encoding media assets according to consumer bit rate requirements), and combines media assets to form items or groupings (e.g., combining a feature movie with a movie trailer, branding art, and advertisements). As used herein, an “item” includes one or more media assets and related metadata and/or other data.

The content management system then preferably selects media content for distribution to particular groups (publishing groups) of consumers based on, for example, geographical location, bit rate service, service provider, and contract terms, and aggregates the selected media content into a rollout. A rollout is a collection of content that is available for exhibition to consumers during a designated window of time. Older rollouts are periodically replaced by newer rollouts in order to provide consumers with fresh media content and to exchange media content based upon contractual obligations associated with the media content.

After selecting media content, the content management system preferably locks the rollout configuration into its final form to prevent any further content selections and to meet distribution deadlines, and transfers the rollout to a staging area for association with and distribution to a storage location. After distribution, consumers may be directed to the rollout for a predetermined period of time while another rollout is prepared for a subsequent viewing period.

After media content is prepared for distribution by a content management system, the distribution system of the present invention designates a storage location for each rollout selected for distribution, builds or programs a delivery data structure, and sends the rollout to the designated storage location. In order to accomplish this, the system of the present invention preferably uses a sending processor operable to deliver a collection of media content over a network (wire or wireless) to at least one storage location, and a receiving processor at each storage location operable to receive the collection of media data from the sending processor and either build or refresh a content database based on the collection of media content received, the content database being accessible by at least one consumer for a selected interval of time. As used herein, the term “refreshing” includes any one of or any combination of adding media content to a medium adapted to store the media content, removing media content stored on the medium, and replacing, editing, or otherwise modifying media content stored on the medium. The receiving processor may be programmed to collect and report content usage (e.g., the amount of time the media content was viewed or listened to and consumer viewing or listening habits), and collect and report demographic data of a consumer using the media content. Such data and information may then be used to select media content to add to, supplement, or replace existing media content stored on the content database.

The sending processor preferably includes a computer-based graphical user interface for retrieving a set of menu entries representative of a collection of media content whereupon a system operator (i.e., person overseeing the content distribution) may select a collection of media content for distribution.

The graphical user interface preferably includes a set of menu entries representative of publishing groups whereupon a system operator selects a publishing group to build a content database. Part of the information that may be contained in the publishing group is the location of media servers used by the consumers that are part of that publishing group as determined by a subscriber management system, which creates and manages consumer accounts.

The sending processor is preferably used to distribute a selected collection of media content to the selected storage location and route consumers to the selected collection of media content. Higher bandwidth content such as movies are distributed to one or more locations accessible to a medium for delivering high bandwidth, for example, a local Internet provider's broadband network or a cable head end. After distribution of content to one or more storage locations, consumers are then able to access the collection of stored media content being offered to them and select videos for streaming to the consumer location.

In another preferred embodiment, the content management system aggregates the selected media content into a “package” (a delivery and storage data structure capable of delivering one or more items at a time) to form a part of a publishing group database (“PGD”). The PGD is a collection of media content that is offered to a designated group of consumers. Older items in the PGD are periodically replaced by newer items in the PGD in order to provide consumers with fresh media content.

Media content is distributed to consumers preferably using methods described herein which include the reporting and licensing of media content shown to consumers, thus providing content suppliers with an accurate accounting of the use of their media content.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a schematic diagram of physical components of a preferred embodiment of the present invention;

FIG. 2 is a schematic diagram of physical components of another preferred embodiment of the invention;

FIG. 3 is a Venn diagram showing the relationship between new media content and old media content in the generation of an addition list and deletion list;

FIG. 4 is logic diagram of a preferred method for distributing media content;

FIG. 5 is a schematic diagram of a preferred architecture of localized components in relation to the central server of FIG. 1;

FIG. 6 is a logic diagram of a preferred method for the delivery of media content to a viewer;

FIG. 7 is a logic diagram of a preferred ad procedure for use with the method of FIG. 6;

FIG. 8 is a schematic diagram of physical components of another preferred embodiment of the invention; and

FIG. 9 is a logic diagram of another preferred method for the delivery of media content to a viewer.

### DESCRIPTION OF THE PREFERRED EMBODIMENTS

Reference will now be made in detail to the present preferred embodiments of the invention, examples of which are illustrated in the accompanying drawings.

The present invention in a preferred embodiment is directed to a content distribution system for distributing content media, preferably in the form of a rollout to one or more storage locations, and for distributing media content to consumers. In addition, the content distribution system of the present invention may distribute media content external to the rollout, as may be the case for video commercials. A rollout is a collection of content for exhibition to consumers during a designated time period. Rollouts are assembled in a content management system and preferably include metadata, static images, and low bandwidth media content. Media assets include, for example, media content provided by a content supplier such as movies, music, and literary works. Metadata is descriptive information associated with a media asset. Rollouts are preferably distributed to central and/or regional storage locations for accessing by a consumer though a digital media service (e.g., digital cable service). High bandwidth media content (e.g., video) is distributed to one or more locations accessible to a medium for delivering high bandwidth, for example, a local Internet provider's broadband network.

Rollouts may be inactive or active. An inactive rollout is any rollout that is not currently available to consumers. An active rollout is any rollout that is currently available to consumers. The content distribution system of the present invention can activate or deactivate rollouts in a manner that is seamless to the consumer. For example, if the consumer is watching, or has purchased a twenty-four hour license to watch a movie that is part of a rollout expected to be deactivated and replaced during the movie or license period, the exchange of rollouts must not affect the consumer's enjoyment of the movie. To ensure a seamless exchange of rollouts, the content distribution system uses business logic to maintain content on the digital media service that is currently being viewed or under license by a consumer, preferably in a temporary storage location. Once the consumer has finished using the content, or their license expires, the content is removed from the service and is no longer available to the consumer. The removal of expired content from the service does not affect the newly activated rollout available to consumers.

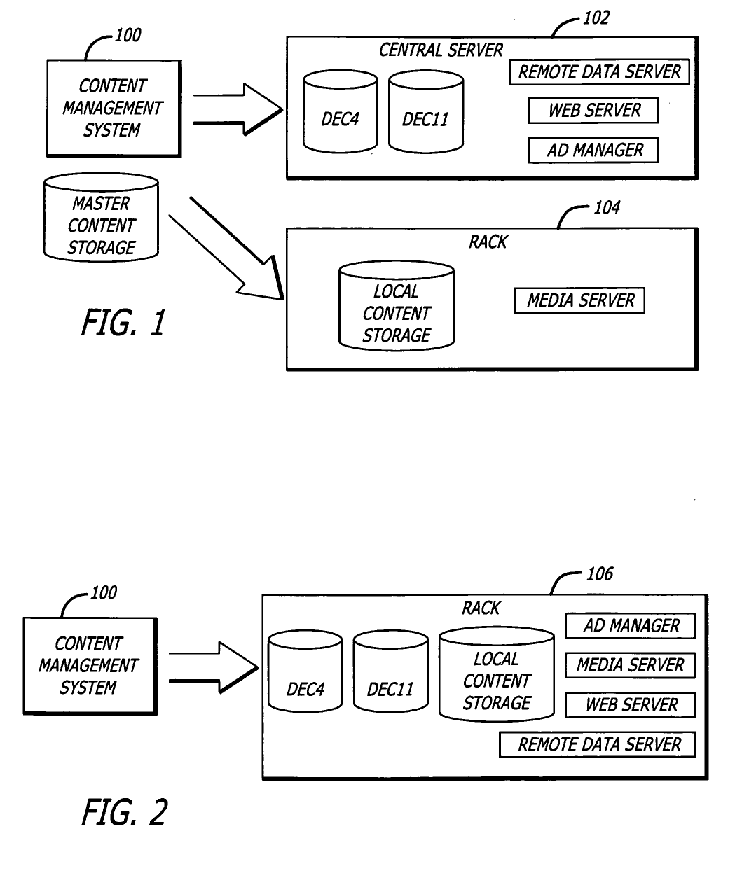

As shown in FIG. 1, the system of the present invention distributes rollouts from a content management system 100 to a central server 102, and controls the delivery of content from a master content storage associated with content management system 100 to a storage device accessible to a local media server, preferably a video server on rack 104. The system of the present invention may also distribute static images and low bandwidth media to central server 102. Content management system 100 packages media assets with metadata and builds the media content into a rollout. A preferred example of a content management system operable with the present invention is taught in U.S. application Ser. No. 09/921,100, titled “Content Management System,” filed Jul. 31, 2001, which claims priority to U.S. Application Ser. No. 60/280,691, the disclosures of which are hereby incorporated by reference herein.

Rack 104 is preferably located in the vicinity of a local service provider (e.g., an Internet or cable service provider) to take advantage of the provider's broadband network and includes a media server and a content storage database. By locating rack 104 near a service provider, the service provider's broadband network may be utilized to stream video contents to consumers. Media content is preferably encrypted and delivered (e.g., on tape) for placement in the media server at rack 104 and may be delivered in known ways. As will be appreciated by those skilled in the art, content may be centrally stored for direct distribution to consumers by utilizing a communications network (wire or wireless, e.g., cable, DSL, satellite, and land-based wireless systems such as cell phone technology) that is adapted to deliver broadband service over a large geographic region.

Each rollout is distributed to a central server 102 and stored in a database, preferably at regular intervals of time, for example, bi-weekly. Each rollout has a viewing window during which time consumers can watch or otherwise use content included as part of the rollout. Each subsequent new rollout supplants or replaces the previous rollout. For example, a rollout with a viewing window between December 4 and December 18 may be supplanted a week later by a rollout with a viewing window between December 11 to December 25. An overlapping viewing window is preferred in case a subsequent rollout is late in delivery. Once the new rollout has been created, platform operators (those overseeing content distribution) can redirect consumers to the new rollout and delete the old rollout from central server 102. Consumers are preferably directed to a particular rollout based their publishing group. Therefore, multiple rollouts may exist on central server 102 and consumers may be directed to certain rollouts as determined by their publishing group.

Older rollouts may also be refreshed by identifying media content to be offered to the consumers during a selected interval of time and refreshing the rollout with the identified media content. Media content may be refreshed based on, for example only, any one of or a combination of consumer-related criteria such as geographical location, demographics, content usage (e.g., the amount of time the media content was viewed or listened to and consumer viewing or listening habits), and parental controls; and/or contractual obligations associated with the media content (e.g., bit rate service, service provider, encryption, price, price range, time frame available for offering the media content to consumers).

Central server 102 also may include a web server, an ad manager and a remote data server. The web server enables central server 102 to distribute and receive content and other data using an Internet protocol such as hypertext transfer protocol (HTTP). The ad manager is preferably a software-based application that enables targeting of advertisements based on specified criteria, including, for example, consumer demographics, time, geographic location and the user interface screen the consumer is currently viewing (or has viewed) on the digital media service. The remote data server allows the content distribution system to distribute content external to a rollout.

FIG. 2 shows another preferred embodiment of the invention wherein one or more rollouts are stored in a rack 106. This allows for quicker response times when delivering content to a consumer and also provides increased portability. Examples of preferred systems operable with the present invention are described in U.S. application Ser. No. 09/922,651, titled “Systems and Methods for Delivering Media Content,” filed Jul. 31, 2001, which claims priority to U.S. Application Ser. No. 60/255,725, the disclosures of which are hereby incorporated by reference herein.

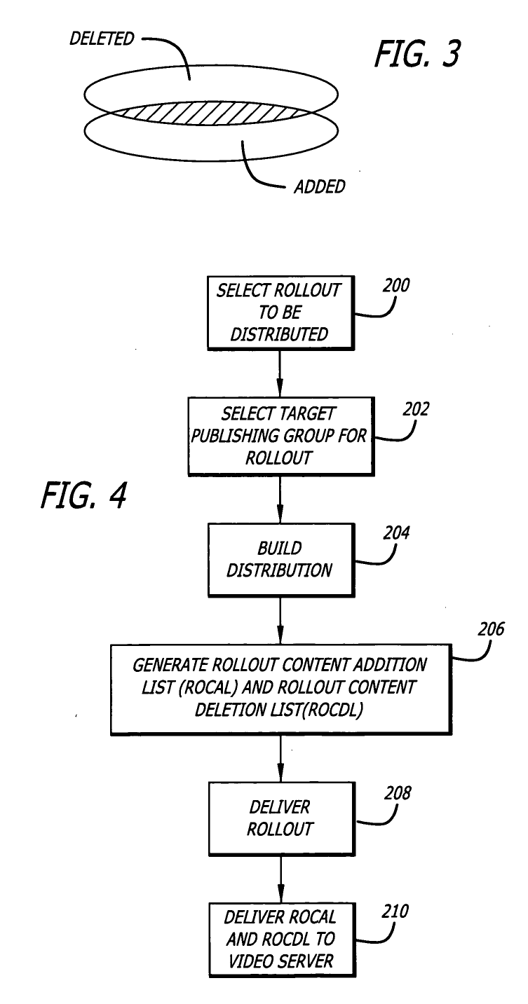

In addition to delivering a rollout to central server 102, the system of the present invention also compares the contents of an active rollout with a newly prepared rollout to generate two lists: a rollout content addition list (ROCAL), and a rollout content deletion list (ROCDL). The ROCAL identifies the items being added in the new rollout and is used to create recordings (e.g., tapes) of new content that are sent to rack 104 for installation on the media server. Another preferred method of this invention is to use the ROCAL file as input parameters to a sending processor. The sending processor aggregates the content into a staging area on the storage device and sends the media assets via a virtual private network or satellite link to the storage device associated with the local media servers. A ROCDL identifies the items being deleted from the current rollout and is used to delete expired content from the media server at rack 104. The relationship between additions and deletions is illustrated in the Venn diagram in FIG. 3. The hashed area in FIG. 3 represents content that remains on the media server from a previous modification. Therefore, unlike a rollout, which is preferably replaced entirely, media at the media server on rack 104 is replaced by titles according to addition and deletion lists. The system also may create a rollout content total list (ROCTL), which identifies each item (a title which has assets that make up the viewing content for the title) in a rollout along with its associated assets (e.g., a feature movie, a movie trailer, ads, and logos). The ROCTL file may be used as a checksum to determine that all the assets required for a given rollout are present before the rollout is made active.

FIG. 4 shows a preferred method for distributing media content to one or more storage locations. In step 200, a platform operator selects a rollout to be distributed. The selection may be made, for example, via a pull-down menu on a system graphic user interface. In step 202, the platform operator selects a target publishing group for the rollout. The server location for the targeted publishing group is preferably centrally located, however, the server may also be located regionally or locally as shown in FIG. 2. A centrally located server increases system efficiency, while regional servers allow quicker response times for consumers. In step 204, the system operator preferably builds the distribution rollout at a workstation (e.g., Unix workstation). This step may be performed automatically by an appropriate program with input values determined by the content management system. In step 206, rollout content addition and deletion lists are generated by comparing a current or previous rollout with a newly planned rollout. In step 208, the rollout is delivered upon a command preferably sent by the system operator. In step 210, the rollout content addition and deletion lists are entered into distribution programs executed on the master storage device to modify selected media content at the media server. These distribution programs may differentiate between media types and send static images and low bandwidth media to centrally located web servers, and send high bandwidth ad media that originated outside of the rollout to the ad manager.

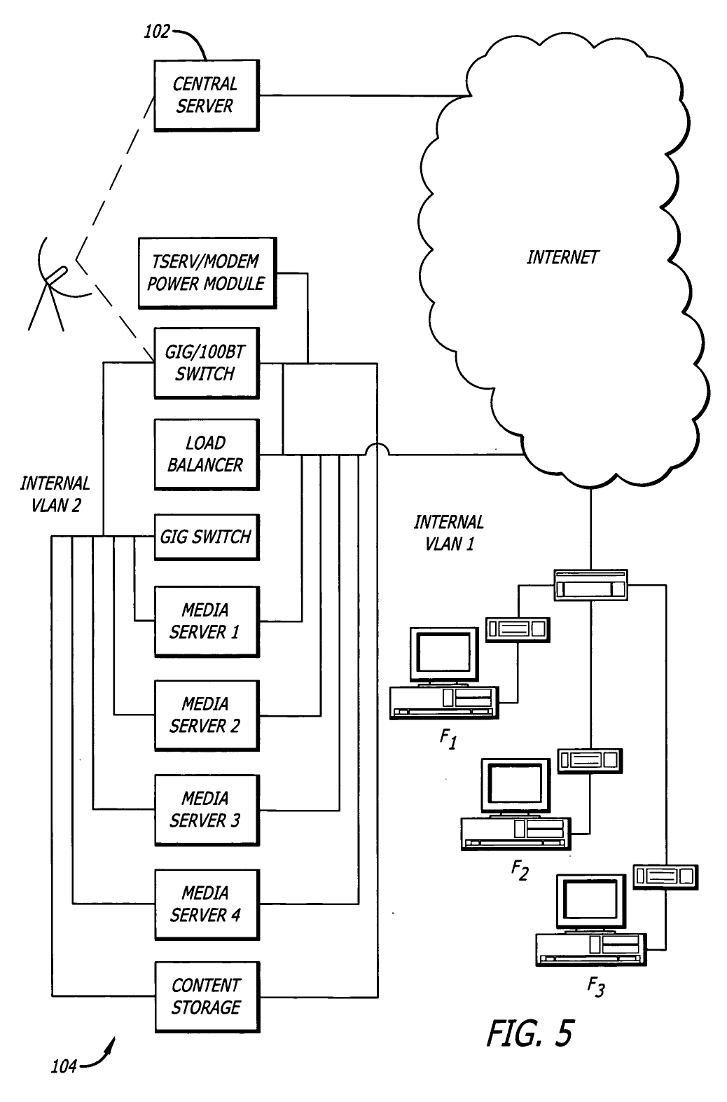

The physical delivery of the rollout to a storage location may be accomplished in a number of ways, for example, using virtual private networks, satellite, microwave and other wireless and cable based mediums. FIGS. 5-7 illustrate a preferred method of distributing media content to consumers. As shown in FIGS. 1 and 5, rack 104 includes content storage for storing encrypted media content, preferably high bandwidth streaming media content such as video, and at least one media server, preferably a plurality of media servers situated in a media server farm. Rack 104 may also include ad content storage for storing high bandwidth streaming ad content. It is to be understood that both the media content storage and ad content storage may be combined into one larger content storage device, or ad content may be omitted altogether. Also, media servers may be arranged in any manner suitable for the distribution of any suitable combination of video content and ad content. Rack 104 is preferably located at or near a service provider in order to take advantage of a provider's broadband network. In use, stream requests from consumers are load-balanced among multiple available media servers. In addition to load-balancing, having multiple media servers allows for a fail-over in the event of hardware or other failure. Additional servers may be added as necessary. Preferably, content is made available to the media servers through a private Gigabit Ethernet (GigaE) Virtual Local Area Network (VLAN). The load balancer provides the GigaE interface to the broadband network and also provides load balancing between the media servers. The GigaE switch provides the backbone private Gigabit Ethernet network between the media servers and content storage. Content storage is preferably through a network-attached fileserver.

FIG. 5 shows a schematic of a preferred embodiment of the interaction between central server 102 and the local network. Central server 102 is preferably positioned to interact with both the consumer and rack 104. Central server 102 may communicate with either of these entities via the Internet, land-based wireless systems such as cell phone technology, DSL, satellite, or cable connections. As shown in rack 104 and explained above, media servers 1-4 are connected to a load balancer which helps distribute content deliveries to consumers in a more efficient manner. The media servers are preferably encoded at various rates including 384 kbps and 750 kbps using an MPEG-4 algorithm and encrypted. Terminal servers/modem hardware is preferably installed in rack 104 to provide backup remote and console access. Administrative access to the rack is preferably only allowed through the virtual private network (VPN). The VPN device is used to establish a secure communication channel between the rack and a system central office. Central server 102 and all the media servers are preferably built with two network interfaces, which allow them to communicate on both the broadband network and the private VLAN. For security reasons, all the interfaces connecting to the broadband network are preferably only configured with access to the services used for streaming and web serving.

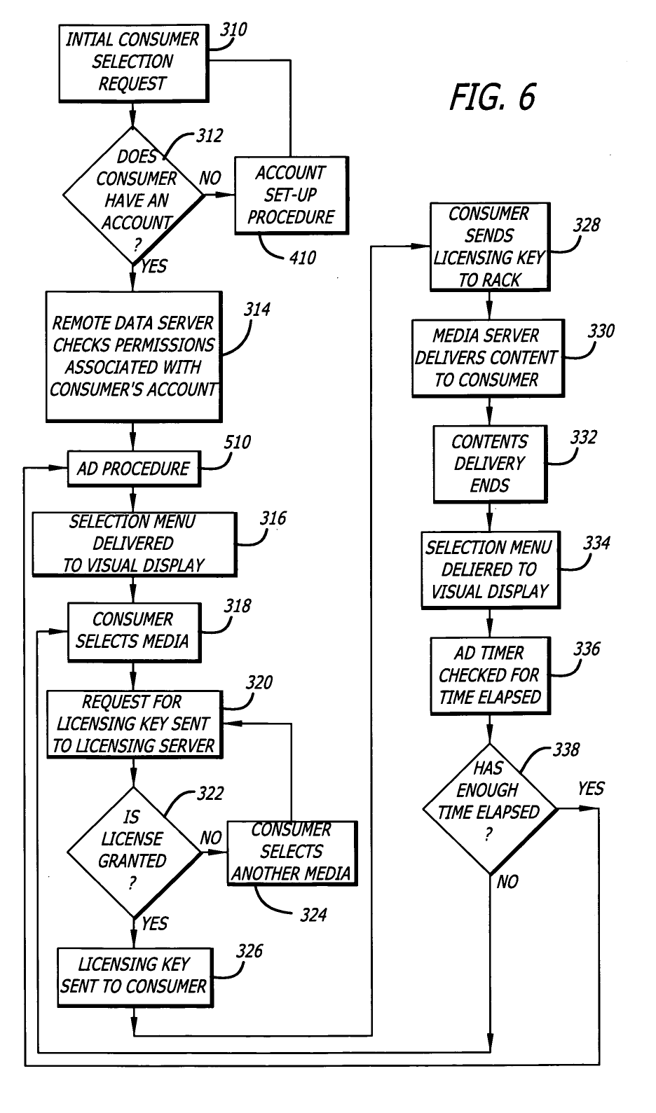

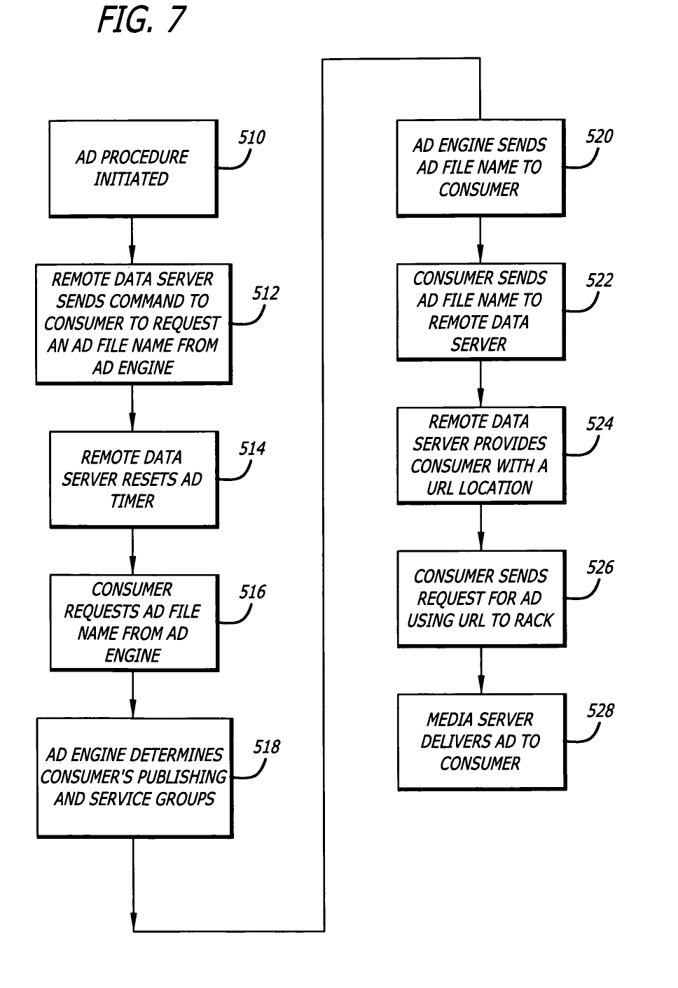

As shown in FIGS. 6 and 7, a preferred method of media content distribution to consumers is illustrated. In step 310, a consumer with web browser access makes a selection request after accessing a provider website. It should be understood that the selection request may also be made through the central server as well. A remote data server or applications server located in central server 102 consults an accounts database to see if the consumer has an account in step 312. If the consumer does not have an account, an account set-up procedure may be initiated in step 410 or the consumer is denied access. The account may be set-up automatically or manually over the phone using known methods. A preferred accounting system operable with the present invention is described in U.S. application Ser. No. 09/921,107, titled “Subscriber Management System,” filed Jul. 31, 2001, which claims priority to U.S. Application Ser. No. 60/280,664, the disclosures of which are hereby incorporated by reference herein. Following the account set-up procedure, the consumer is then permitted to continue. If the consumer has an account, then the remote data server checks the permissions associated with the consumer's account in step 314. These permissions can be, for example, restrictions on a particular genre of content or spending amounts associated with a family member of a head-of-household account. Though preferred, the present invention need not include an accounting procedure. Following step 314, an ad procedure 510 is initiated (described below).

As shown in FIG. 7, ad procedure 510 is commenced when the consumer or the consumer's visual display (e.g., computer, television set, or other audio-visual device) requests an ad file from an ad engine in step 512. The ad engine preferably includes a database of file names of ads to be targeted to specific publishing groups of consumers. In step 514, the remote data server resets an ad timer. The ad timer preferably times consumer interaction rather than a particular content. In step 516, the consumer's visual display requests the ad file name from the ad engine. In step 518, the ad engine determines the consumers publishing group and service group (e.g., bit rate service requirement) by accessing a database shared by the subscriber management system. In step 520, the ad engine sends the ad file name to the consumer's visual display. Thereafter, the consumer's visual display sends the request for an ad using a universal resource locator (URL) to rack 104 in step 526. The media server in step 528 delivers the ad to the consumer, thus completing an ad procedure. During the ad procedure, it is understood that one or more steps may be interchanged with others. For example, step 514, resetting the ad timer, may be accomplished anywhere during the ad procedure. Additionally, this ad procedure is preferred for streaming media advertisements. It is understood of course, that advertisements of lower bandwidth may be stored on central server 102, for example in the web server. In such an instance, the procedure may be confined totally to central server 102, or if the high bandwidth advertisement media and low bandwidth advertisement media are both to be used, the procedure may be readily adaptable to include interaction between both the web server and rack 104 (see FIG. 1). Another example of a preferred ad procedure may be found in U.S. application Ser. No. 09/825,758, titled “Internet Protocol-Based Interstitial Advertising,” the disclosure of which is hereby incorporated by reference. Though preferred, the ad procedure may be omitted and not affect the distribution of content to the consumer.

As shown in FIG. 6, after completion of ad procedure 510, the remote data server delivers a selection menu to the consumer's visual display in step 316. In step 318, the consumer selects the media content they want to see. In step 320, the consumer's visual display transmits a request for a licensing key for a decryption program to the licensing server. The licensing server is responsible for handling licensing requests and issuing license keys for decryption programs to end consumers requesting a particular media content. Preferably, decryption programs are served by an independent third party. The licensing server preferably cooperates with the account management system in reporting royalties to content owners. In step 322, the licensing server either grants a license or a denies a license. If the licensing server denies a license, then in step 324 the consumer selects another media content to view and repeats step 320. Once a license is granted, in step 326 a licensing key and decryption program is sent to the consumer's visual display. The consumer's visual display in step 328 sends the licensing key and decryption program to the rack 104. The media server in step 330 decrypts and delivers the media content to the consumer.

Once content delivery ends in step 332, the data server generates a selection menu using data retrieved from the rollout in step 334. In step 336, the ad timer is checked for time elapsed. At this point, the remote data server determines if enough time has elapsed in step 338. If the time interval for initiating another ad procedure 510 has not elapsed, then the consumer proceeds to make a selection as in step 318 from a selection menu in step 316, thus repeating steps 318 through 332. However, if enough time has elapsed since the last ad procedure 510, then ad procedure 510 is again initiated. After completion of the second ad procedure 510, steps 316 through 338 are repeated. As will be appreciated by those skilled in the art, various of the above steps may be interchanged or omitted. For example, if no ad procedure is used, steps 510, 336, and 338 may be omitted. Additionally, instead of sending a licensing key to the consumer in step 326, the key may be sent directly to the rack to begin content delivery to the consumer, thereby omitting steps 326 and 328.

In another embodiment of the present invention, instead of replacing a rollout with a subsequent rollout to provide consumers with fresh media content, a publishing group database (“PGD”) may be used. The PGD may be refreshed without time or quantity restrictions (i.e., one or more items may be added to the PGD, deleted from the PGD, replaced, edited, or otherwise modified in the PGD at any time by the system or the system operator). This may be accomplished by associating one or more items with a “package.” The “package” is a delivery data structure capable of delivering one or more items to a destination (e.g., central server 102 or rack 106). Packages may be created, for example, by associating a unique identifier of selected items with the package data structure.

Once delivered to the destination, the package preferably forms a part of the PGD and functions to store the item(s) until such time a command is received to add, delete, replace, edit, or otherwise modify the package or any of the items therein. Packages may be programmed with begin dates and end dates so that the items associated with a particular package preferably will be offered to consumers for only a selected interval of time. Packages also may be utilized to deliver item remove commands to the PGD. For example, a package being offered to consumers on a PGD may be copied and one or more items deleted from the package. The revised package may then be delivered to the PGD to replace the package currently being offered.

Media content stored on the PGD may be refreshed based on, for example only, any one of or a combination of consumer-related criteria such as geographical location, demographics, content usage (e.g., the amount of time the media content was viewed or listened to and consumer viewing or listening habits), and parental controls; and/or contractual obligations associated with the media content (e.g., bit rate service, service provider, encryption, price, price range, time frame available for offering the media content to consumers).

A preferred method of content distribution to consumers utilizing a PGD may be performed using the method illustrated in FIGS. 6 and 7, except that a selection menu may be generated using data retrieved from the PGD instead of a rollout.

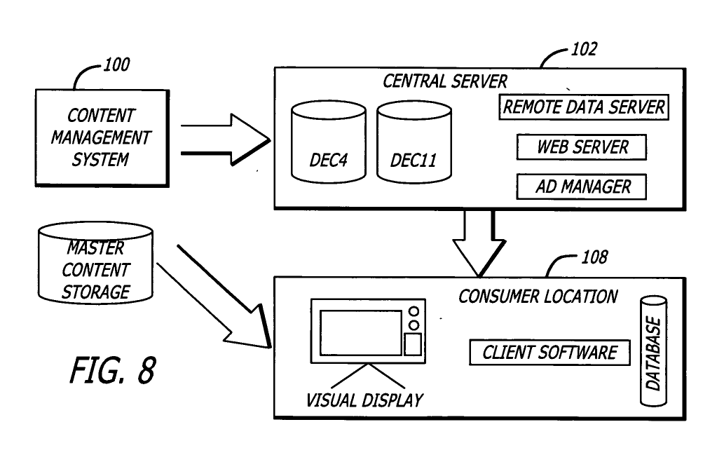

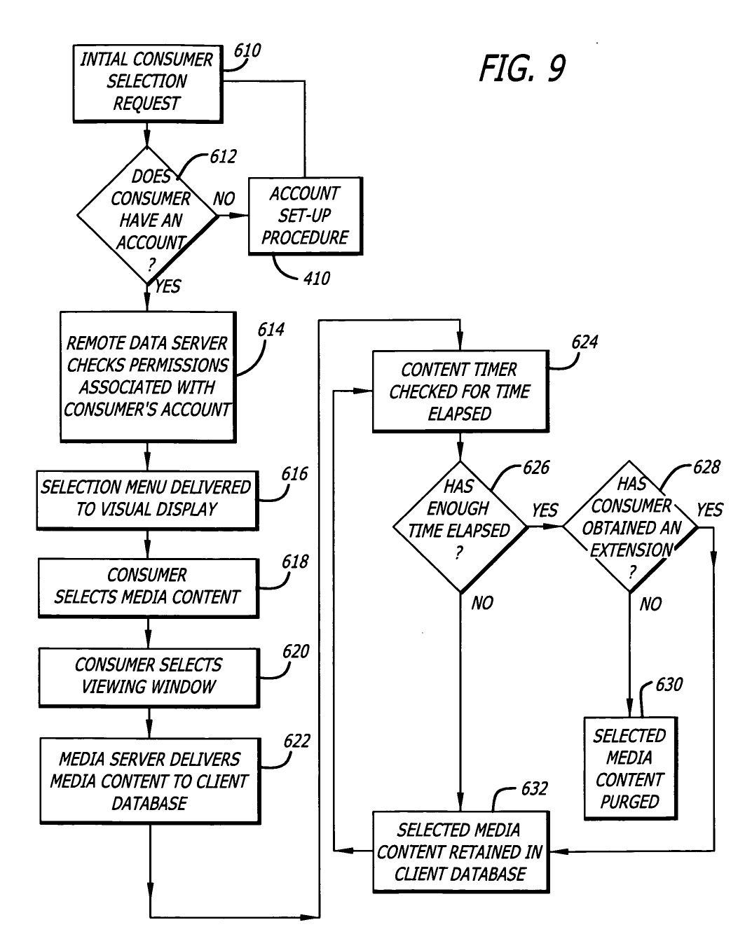

FIGS. 8 and 9 show another preferred embodiment of the present invention. The embodiment of FIG. 8 is similar to that of FIG. 1 except that media content is pushed to and downloaded by a receiving processor to a client content database at consumer location 108 instead of the content database at rack 104. Pushing media content directly to consumer location 108 lowers system costs and provides a better quality product, particularly if the media content is pushed during non-peak hours over a communications network. Client software on the receiving processor at consumer location 108 may be programmed to provide secure access to the client content database, decrypt encrypted media content, and track media content stored on the client content database. The client software may also be programmed to collect and report content usage (e.g., the amount of time the media content was viewed or listened to), collect and report demographic data, and collect and report the consumer's viewing or listening habits. The client software is preferably programmed to include a content timer to measure the total amount of time the selected media content has been stored on the client content database and purge the selected content from the client content database after a selected amount of time has elapsed.

The client software may also be programmed for interactivity in selected media content. For example, a “floating bug” program may be included in the client software that indicates areas of interactivity in interactive video content. An example of a preferred system and method for creating interactive content is taught in U.S. application Ser. No. 09/921,097, titled “A System and Method for Interactive Video Content Programming,” filed Jul. 31, 2001, which claims priority to U.S. Application Ser. No. 60/255,541, the disclosures of which are hereby incorporated by reference herein.

FIG. 9 shows a preferred method for the system of FIG. 8. Steps 610-618 generally parallel steps 310-318 in FIG. 6 except that ad procedure 510 has been omitted. As will be appreciated by those skilled in the art, ad procedure 510 may be included in the method in instances where it is desired to deliver ads to the consumer. In step 620, the consumer selects a viewing window. The viewing window represents the time frame the consumer will have access to the media content selected (including audio content). Preferably, the entity providing the media content will set the total amount of time in the viewing window, e.g., three days, and the consumer will select the time frame desired for having the media content available for use, e.g., Thursday-Sunday. It will be appreciated by those skilled in the art that if desired, the consumer may be given the option to increase or decrease the total amount of time in the viewing window for selected media content. For example, if a consumer has selected a movie and has not watched the entire movie by the end of the last day of the viewing window, the consumer may be provided with an opportunity to obtain or purchase a one-day extension. Alternatively, the consumer may have total control in selecting the amount of time available to access a given media content. For example, with a video subscription service, the consumer may purchase six hours of access to television show X and four days of access to movie Y with access charges being levied depending upon media content type and total amount of access time purchased.

The viewing window may be system activated (i.e., the client software may commence timing the viewing window at the completion of the download) or consumer activated (i.e., the client software may commence timing the viewing window when the consumer first accesses the selected media content from the client content database).

In step 622, the media server delivers the selected media content to the client content database. Preferably, the media content is pushed to and downloaded by the receiving processor the client content database over the communications network during non-peak hours (e.g., midnight to 5 A.M.) when network access is greater. Delivering the media content during non-peak hours allows delivery to be made using a lower bandwidth, thereby reducing operating costs. The media content may be delivered from any storage location where the media content is kept, e.g., from a master content storage facility or from a local content storage facility at rack 104. Once downloaded, the selected media content may be decrypted (if encrypted) and made available to the consumer by the client software. If desired, the client software may be programmed to require an access code to view the downloaded media content.

In step 624, the content timer is checked for the time elapsed. More than one amount of time may be measured. For example, if the viewing window is consumer activated, the client software may be programmed to track the completion of the download (e.g., 4 A.M.) for measuring the total amount of time the selected media content has been available for use, and commence timing a consumer activated viewing window activated at 9 A.M.

In step 626, it is determined if enough time has elapsed. The client software is preferably programmed to block access to the selected media content at the expiration of a selected amount of elapsed time, for example, the viewing window. In systems using the consumer activated viewing window, the selected amount of elapsed time may expire at the earliest of the expiration of the consumer activated viewing window or a pre-determined maximum amount of time. For example, if the predetermined maximum amount of time is five days (measured from completion of downloading), and a consumer activated viewing window of three days is not activated until the fourth day, the client software blocks access to the selected media content at the end of the fifth day regardless of any time remaining in the consumer activated viewing window.

If the selected amount of time has elapsed, then the client software blocks consumer access to the selected media content and in step 628 it is determined if the consumer wants an extension of time to prolong access to the selected media content. If the consumer does not want an extension, then in step 630 the client software automatically purges the selected media content from the client content database. As will be appreciated by those skilled in the art, the client software may be programmed to offer an extension without blocking access. The client software may also automatically purge the selected media content without offering any extension.

If enough time has not elapsed in step 626, or if the consumer obtains an extension of time in step 628, the selected media content is retained in the client content database in step 632 and step 624 is repeated.

As will be appreciated by those skilled in the art, the above steps need not be performed in the described order. Various steps may be re-ordered or omitted, or new steps added. For example, additional steps may be provided offering the consumer the opportunity to purchase and keep the selected media content. The client software may then be programmed to permit the user unlimited access to the purchased media content. Copying restrictions may be included to prevent the consumer from copying the purchased media content without permission.

The client software may be programmed for use in a media content sales system. In such a system, the client software may provide many of the same security measures while acting as a receiving agent for a digital content purchased by the consumer from a digital content sales site.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for distributing digital video content, the system comprising:
a sending processor operable to distribute video content over a network to at least one storage location, the video content including a plurality of media assets and associated metadata combined into groupings, the groupings determined by at least one criteria common to the media assets and not determined by content preference supplied by an individual consumer in at least one group of consumers, the sending processor operable to aggregate the groupings into at least one rollout based on at least one common criteria of the individual consumers in the at least one group other than content preference supplied by an individual consumer, the media assets in the rollout being presented to each of the individual consumers in the at least one group; and
a receiving processor at each storage location operable to receive the video content from said sending processor and refresh a content database based on the video content received, said content database adapted to provide the at least one group of consumers access to the video content stored therein for a predetermined interval of time having a programmed begin date and a programmed end date.

2. The system of claim 1, wherein said receiving processor is operable to refresh said content database based on the at least one common criteria of the consumers.

3. The system of claim 2, wherein the at least one common criteria of the consumers includes the content usage by the consumers.

4. The system of claim 3, wherein the content usage includes the viewing habits of each consumer.

5. The system of claim 3, wherein the content usage includes an amount of time each consumer views the content.

6. The system of claim 1, wherein said receiving processor is operable to refresh said content database based on one or more contractual obligations associated with the content.

7. The system of claim 1, wherein said groupings are determined without collecting preferences for previously viewed content from the individual consumers in the at least one group of consumers.

8. A method for refreshing video content stored on at least one content database, the method comprising the steps of:
selecting at least one content database;
identifying video content to be offered to at least one consumer during a predetermined interval of time having a programmed begin date and a programmed end date, the video content including a plurality of media assets and associated metadata combined into groupings, the groupings determined by at least one criteria common to the media assets and not determined by content preference supplied by an individual consumer in at least one group of consumers, the groupings aggregated into at least one rollout based on at least one common criteria of the individual consumers in the at least one group other than content preference supplied by an individual consumer, the media assets in the rollout being presented to each of the individual consumers in the at least one group; and
refreshing each content database with the identified video content.

9. The method of claim 8, wherein said refreshing step is based on the at least one common criteria of the consumers.

10. The method of claim 9, wherein the at least one common criteria of the consumers includes the content usage by the consumers.

11. The method of claim 10, wherein the content usage includes the viewing habits of each consumer.

12. The method of claim 10, wherein the content usage includes an amount of time each consumer views the content.

13. The method of claim 9, wherein said refreshing step is based on one or more contractual obligations associated with the content.

14. The method of claim 8, wherein the groupings are determined without collecting preferences for previously viewed content from the individual consumers in the at least one group of consumers.

15. A method for distributing digital media content to one of a plurality of storage locations, the method comprising the steps of:
selecting media content, the media content including a plurality of media assets and associated metadata combined into groupings, the groupings determined by at least one criteria common to the media assets and not determined by content preference supplied by an individual consumer in at least one group of consumers, the groupings aggregated into at least one rollout based on at least one common criteria of the individual consumers in the at least one group other than content preference supplied by an individual consumer, the media assets in the rollout being presented to each of the individual consumers in the at least one group;
identifying at least one of the storage locations for receiving the selected media content;
distributing the selected media content to each identified storage location; and
offering the selected media to at least one of the consumers for a predetermined interval of time having a programmed begin date and a programmed end date.

16. The method of claim 15, wherein the at least one common criteria of the consumers includes the content usage by each consumer.

17. The method of claim 16, wherein the content usage includes the viewing habits of each consumer.

18. The method of claim 16, wherein the content usage includes the listening habits of each consumer.

19. The method of claim 15, wherein said selecting step is further based on one or more contractual obligations associated with the content.

20. The method of claim 15, wherein the groupings are determined without collecting preferences for previously viewed content from the individual consumers in the at least one group of consumers.
